(19) United States
(12) Patent Application Publication
(10) Pub. No.: US 2019/0266646 A1
(43) Pub. Date: Aug. 29, 2019

(54) Real-Time Advertisement Preparation System

(71) Applicant: ARRIS Enterprises LLC, Suwanee, GA (US)

(72) Inventors: Matthew A. Milford, Waxhaw, NC (US); Xavier P. Denis, Beaverton, OR (US); David A. Romrell, Hillsboro, OR (US)

(21) Appl. No.: 16/284,378

(22) Filed: Feb. 25, 2019

Related U.S. Application Data
(60) Provisional application No. 62/634,328, filed on Feb. 23, 2018.

(51) Int. Cl. G06Q 30/02; H04L 29/08

(52) U.S. Cl. CPC G06Q 30/0276; G06Q 30/0277; G06Q 30/0244; H04L 29/08657

(57) ABSTRACT

Methods, systems, and computer readable media can be operable to facilitate real-time advertisement preparation. An advertisement preparation system may retrieve requested advertisement media from a third party source. Based upon an identification of a targeted client device that is to receive the advertisement media, the advertisement preparation system may determine delivery specifications associated with the targeted client device. The advertisement preparation system may transcode the retrieved advertisement media according to the delivery specifications associated with the targeted client device, and the transcoded advertisement media may be delivered to the targeted client device.

### CROSS REFERENCE TO RELATED APPLICATION

This application is a non-provisional application claiming the benefit of U.S. Provisional Application Ser. No. 62/634,328, entitled “Real-Time Ad Preparation System,” which was filed on Feb. 23, 2018, and is incorporated herein by reference in its entirety.

### TECHNICAL FIELD

This disclosure relates to a system for real-time advertisement preparation.

### BACKGROUND

Advertisement media that is provided by third party sources is often incorrect for the different client types. For example, lower resolution spliced into a stream that is being viewed on a high-definition display is not aesthetically pleasing. Typically, advertisement media is prepared pre-airdate via an off-line media preparation system and then placed into an ad-serving system. However, advertisement media is not always provided early to the service providers, and often, the advertisement media is provided by third parties. When the advertisement media is provided by third parties at the time of playback, the media does not always meet the quality needed for service providers and/or their services. Additionally, there are often mismatches between the advertisement media delivered and the client types. Therefore, a need exists for improved methods and systems for carrying out real-time preparation of advertisement media.

### BRIEF DESCRIPTION OF THE DRAWINGS

FIG. 1 is a block diagram illustrating an example network environment operable to facilitate real-time advertisement preparation.

FIG. 2 is a block diagram illustrating an example network environment operable to facilitate real-time advertisement preparation through the use of an advertisement decision proxy.

FIG. 3 is a block diagram illustrating an example advertisement preparation system operable to facilitate real-time advertisement preparation.

FIG. 4 is a flowchart illustrating an example process operable to facilitate a retrieval and preparation of advertisement media that is retrieved from a third party source.

FIG. 5 is a flowchart illustrating an example process operable to facilitate a retrieval and preparation of advertisement media that is retrieved from a third party source or delivery network.

FIG. 6 is a flowchart illustrating an example process operable to facilitate a retrieval and preparation of a plurality of advertisement identified from a schedule.

FIG. 7 is a flowchart illustrating an example process operable to facilitate a retrieval and preparation of advertisement media for delivery to a targeted device and one or more other device types.

FIG. 8 is a block diagram of a hardware configuration operable to facilitate real-time advertisement preparation.

Like reference numbers and designations in the various drawings indicate like elements.

### DETAILED DESCRIPTION

It is desirable to improve upon methods and systems for carrying out real-time preparation of advertisement media. Methods, systems, and computer readable media can be operable to facilitate real-time advertisement preparation. An advertisement preparation system may retrieve requested advertisement media from a third party source. Based upon an identification of a targeted client device that is to receive the advertisement media, the advertisement preparation system may determine delivery specifications associated with the targeted client device. The advertisement preparation system may transcode the retrieved advertisement media according to the delivery specifications associated with the targeted client device, and the transcoded advertisement media may be delivered to the targeted client device.

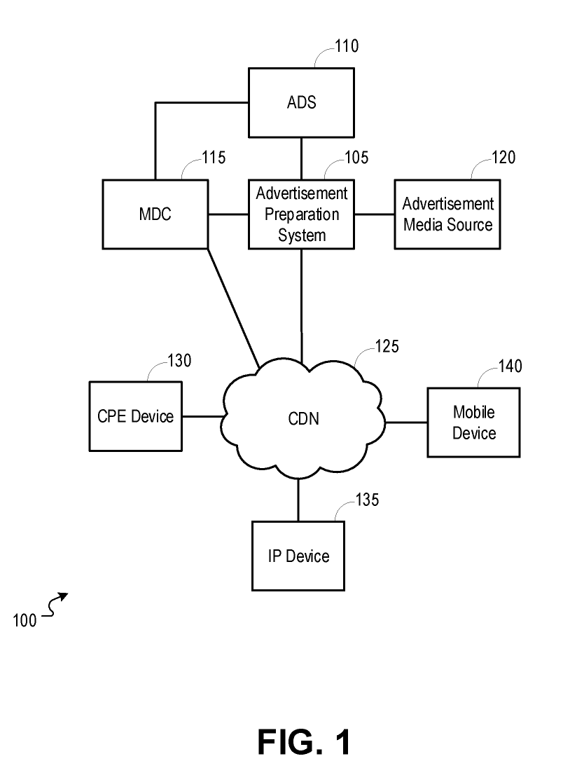

FIG. 1 is a block diagram illustrating an example network environment 100 operable to facilitate real-time advertisement preparation.

In embodiments, an advertisement preparation system 105 may pull advertisement media from third parties and transcode the advertisement media as needed to ensure the advertisement media conforms to delivery specifications that are required for high-quality delivery to a variety of client types. The advertisement preparation system 105 may manage a cache and time-to-live (TTL) of advertisement media.

In embodiments, advertisement preparation by the advertisement preparation system 105 may be triggered in response to a received notice or request that advertisement media is needed or may be needed at a future time.

In embodiments, advertisement preparation by the advertisement preparation system 105 may be triggered by a pre-notice of advertisement media locators (e.g., URL (uniform resource locator)) received from an ADS (advertisement decision service) 110 that provides advertisement media locators. For example, the pre-notice of advertisement media locators may be received from an advertising campaign manager.

In embodiments, advertisement preparation by the advertisement preparation system 105 may be triggered by an early advertisement decision to the ADS 110 for one or more client types where all advertisement media locators are extracted. For example, the ADS may establish one or more test client devices having delivery specifications that match delivery specifications associated with the one or more client types. The advertisement preparation system 105 may retrieve and transcode the requested advertisement media according to the delivery specifications associated with the test client device.

In embodiments, advertisement preparation by the advertisement preparation system 105 may be triggered by a copy of advertisement decisions received from a MDC (manifest delivery controller) 115.

In embodiments, the advertisement preparation system 105 may enable configuration of defined advertisement media formats for each of one or more client types and the advertisement preparation system 105 may ensure that advertisement media conforms with these defined formats. The advertisement preparation system 105 may manage a prioritization queue of all advertisement media requests and may utilize both on-site and cloud based transcoding engines to transcode the requested advertisement media to an appropriate format.

In embodiments, the advertisement preparation system 105 may support HTTP (hypertext transfer protocol) and HTTPs (hypertext transfer protocol secure) requests.

In embodiments, the advertisement preparation system 105 may remap advertisement media locators from an original source (e.g., advertisement media source 120) to new locators prepared by the advertisement preparation system 105. For example, this may map to a managed CDN (content delivery network) 125 that may enable high-quality delivery.

In embodiments, the MDC 115 may retrieve playback information and location information, and the MDC 115 may retrieve a channel manifest and/or an advertisement manifest from a CDN 125.

In embodiments, the advertisement preparation system 105 may provide origin services for new advertisement media that has been prepared in the configured formats.

In embodiments, the advertisement preparation system 105 may enable quality rules to ensure all assets exist, check stream types such as secondary audio, captions, DRM (digital rights management), and others.

In embodiments, the advertisement preparation system 105 may maintain a listing of monitored advertisement media including life cycle tracking and usage reporting. This may be carried out within the MDC 115 at the backend caching.

In embodiments, the advertisement preparation system 105 may maintain an event log of advertisement media that may trigger deferred actions which may also transcode or carry out other tasks (e.g., quality controls, purging bad, etc.).

In embodiments, the advertisement preparation system 105 may enable real-time or deferred monitoring of advertisement media usage to enable quality controls of parameters such as audio levels, GOP (group of pictures) parameters, encoding requirements, watermarks, and/or others.

In embodiments, the advertisement preparation system 105 may allow operator management of a prioritized transcode queue to control response times of restricted resources.

In embodiments, the advertisement preparation system 105 may use the delivery order of advertisement media to control transcode priority. For example, advertisement media scheduled at the end of a break may be transcoded after advertisement media that is scheduled at the start of the break.

In embodiments, the advertisement preparation system 105 may be implemented on systems within service provider networks along with transcoders, or the advertisement preparation system 105 may run completely in the cloud. The advertisement preparation system 105 may leverage modern micro-services software architecture and web serving systems.

In embodiments, the advertisement preparation system 105 may be scalable to support the highest concurrency of real-time advertisement preparation needed to support a service provider's advertising business.

In embodiments, the advertisement preparation system 105 may provide high-quality advertisement delivery by delivering advertisement media that has been formatted by the advertisement preparation system 105 according to configured media formats that are associated with one or more client types.

In embodiments, advertisement media may be retrieved by the advertisement preparation system 105 from a third party source (e.g., advertisement media source 120), and the retrieved advertisement media may be transcoded by the advertisement preparation system 105. The advertisement media may be transcoded according to one or more delivery specifications associated with a targeted client device/device type. For example, delivery specifications may include screen resolution (high-definition, standard-definition, 4K, etc.), screen size, audio level, secondary audio, captions, DRM, GOP parameters, encoding requirements, watermarks, and others.

In embodiments, the transcoded advertisement media may be delivered through the CDN 125 to a CPE (customer premise equipment) device 130, an IP (Internet protocol) device 135, a mobile device 140, or other user device.

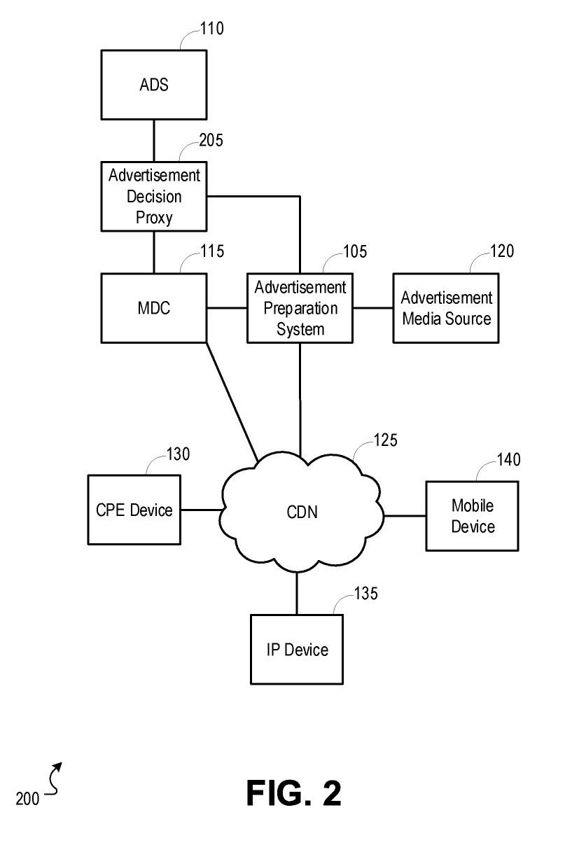

FIG. 2 is a block diagram illustrating an example network environment 100 operable to facilitate real-time advertisement preparation through the use of an advertisement decision proxy 205.

In embodiments, advertisement preparation by the advertisement preparation system 105 may be triggered by a copy of advertisement decisions received from an advertisement decision proxy 205. The advertisement decision proxy 205 may be between the MDC 115 and ADS 110.

In embodiments, advertisement preparation by the advertisement preparation system 105 may be triggered by an advertisement decision proxy 205 that provides advertisement manifests to the MDC 115.

In embodiments, advertisement media may be retrieved by the advertisement preparation system 105 from a third party source (e.g., advertisement media source 120), and the retrieved advertisement media may be transcoded by the advertisement preparation system 105.

In embodiments, the transcoded advertisement media may be delivered through the CDN 125 to a CPE (customer premise equipment) device 130, an IP (Internet protocol) device 135, a mobile device 140, or other user device.

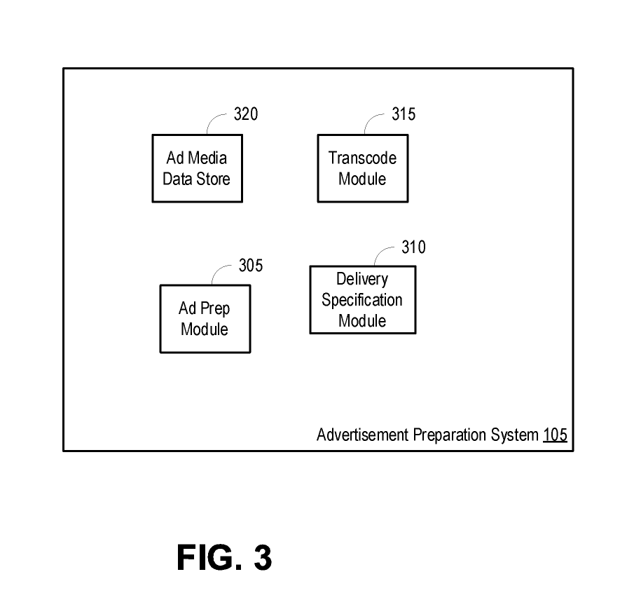

FIG. 3 is a block diagram illustrating an example advertisement preparation system 105 operable to facilitate real-time advertisement preparation. The advertisement preparation system 105 may include an ad (advertisement) prep module 305, a delivery specification module 310, a transcode module 315, and an ad media data store 320.

In embodiments, an advertisement preparation system 105 may pull advertisement media from third parties and transcode the advertisement media as needed to ensure the advertisement media conforms to delivery specifications that are required for high-quality delivery to a variety of client types. The advertisement preparation system 105 may manage a cache and time-to-live (TTL) of advertisement media.

In embodiments, advertisement preparation by the advertisement preparation system 105 may be triggered in response to a received notice or request that advertisement media is needed or may be needed at a future time.

In embodiments, advertisement preparation by the advertisement preparation system 105 may be triggered by a pre-notice of advertisement media locators (e.g., URL (uniform resource locator)) received from an ADS (advertisement decision service) 110 of FIG. 1 that provides advertisement media locators. For example, the pre-notice of advertisement media locators may be received from an advertising campaign manager.

In embodiments, advertisement preparation by the advertisement preparation system 105 may be triggered by an early advertisement decision to the ADS 110 for one or more client types where all advertisement media locators are extracted. For example, the ADS may establish one or more test client devices having delivery specifications that match delivery specifications associated with the one or more client types. The ad prep module 305 may retrieve the requested advertisement media and the transcode module 315 may transcode the retrieved advertisement media according to the delivery specifications associated with the test or targeted client device. It should be understood that a transcoding system that is external to the advertisement preparation system 105 may be used to transcode the retrieved advertisement media.

In embodiments, advertisement preparation by the advertisement preparation system 105 may be triggered by a copy of advertisement decisions received from a MDC (manifest delivery controller) 115 of FIG. 1.

In embodiments, the advertisement preparation system 105 may enable configuration of defined advertisement media formats for each of one or more client types and the advertisement preparation system 105 may ensure that advertisement media conforms with these defined formats. For example, the delivery specification module 310 may be configured with delivery specification associated with one or more different client device types. The delivery specification module 310 may retrieve delivery specifications associated with one or more different client device types. The advertisement preparation system 105 may manage a prioritization queue of all advertisement media requests and may utilize both on-site (e.g., transcode module 315) and cloud based transcoding engines to transcode the requested advertisement media to an appropriate format.

In embodiments, the advertisement preparation system 105 may support HTTP (hypertext transfer protocol) and HTTPs (hypertext transfer protocol secure) requests.

In embodiments, the ad prep module 305 may remap advertisement media locators from an original source (e.g., advertisement media source 120) to new locators prepared by the ad prep module 305. For example, this may map to a managed CDN (content delivery network) 125 of FIG. 1 that may enable high-quality delivery.

In embodiments, the advertisement preparation system 105 may provide origin services for new advertisement media that has been prepared in the configured formats. Transcoded advertisement media may be stored at the ad media data store 320.

In embodiments, the ad prep module 305 may enable quality rules to ensure all assets exist, check stream types such as secondary audio, captions, DRM (digital rights management), and others.

In embodiments, the ad prep module 305 may maintain a listing of monitored advertisement media including life cycle tracking and usage reporting.

In embodiments, the ad prep module 305 may maintain an event log of advertisement media that may trigger deferred actions which may also transcode or carry out other tasks (e.g., quality controls, purging bad, etc.).

In embodiments, the ad prep module 305 may enable real-time or deferred monitoring of advertisement media usage to enable quality controls of parameters such as audio levels, GOP (group of pictures) parameters, encoding requirements, watermarks, and/or others.

In embodiments, the ad prep module 305 may allow operator management of a prioritized transcode queue to control response times of restricted resources.

In embodiments, the ad prep module 305 may use the delivery order of advertisement media to control transcode priority. For example, advertisement media scheduled at the end of a break may be transcoded after advertisement media that is scheduled at the start of the break.

In embodiments, advertisement media may be retrieved by the ad prep module 305 from a third party source (e.g., advertisement media source 120 of FIG. 1), and the retrieved advertisement media may be transcoded by the transcode module 315 or by a transcoding system that is external to the advertisement preparation system 105.

In embodiments, the transcoded advertisement media may be delivered to a CDN 125 of FIG. 1.

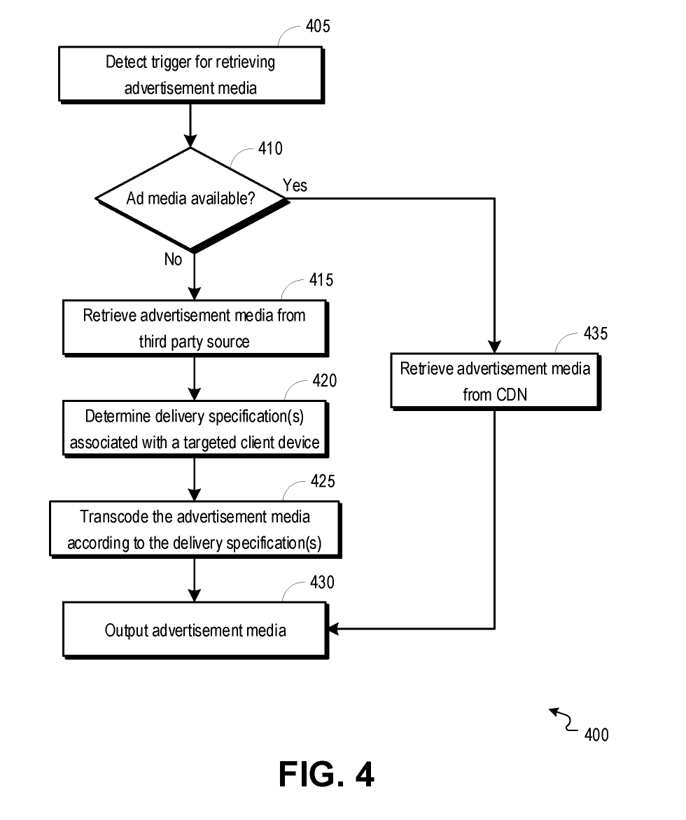

FIG. 4 is a flowchart illustrating an example process 400 operable to facilitate a retrieval and preparation of advertisement media that is retrieved from a third party source. The process 400 may start at 405 when a trigger for retrieving advertisement media is detected. The trigger may be detected, for example, by the advertisement preparation system 105 of FIG. 1. In embodiments, the trigger may be a notice of advertisement media locators (e.g., URLs) or advertisement decisions received by the advertisement preparation system 105 from an ADS 110 of FIG. 1 or advertisement decision proxy 205 of FIG. 2. The trigger may include an identification of the advertisement media to be retrieved and an identification of one or more client devices or client types that are to receive the advertisement media. For example, the identification of the advertisement media may include a unique identifier associated with the advertisement media, a locator (e.g., URL) associated with the advertisement media, or other identifier.

At 410, a determination may be made whether the advertisement media identified by the trigger is available. The determination whether the advertisement media is available may be made, for example, by the advertisement preparation system 105. In embodiments, the advertisement preparation system 105 may determine whether the advertisement media is available for delivery to the one or more identified client devices or client types. For example, the advertisement preparation system 105 may determine whether the advertisement media is available within a CDN (e.g., CDN 125 of FIG. 1).

If, at 410, the determination is made that the advertisement media is not available, the process 400 may proceed to 415. At 415, the advertisement media may be retrieved from a third party source. For example, the advertisement media may be retrieved from the third party source (e.g., advertisement media source 120 of FIG. 1) by the advertisement preparation system 105. The third party source may be a source of advertisement media that is located outside of the CDN 125. Using the identification of the advertisement media (e.g., locator, unique identifier, etc.), the advertisement preparation system 105 may retrieve the advertisement media from the third party source.

At 420, delivery specification(s) associated with a targeted client device may be determined. Delivery specification(s) associated with the targeted client device may be determined, for example, by the advertisement preparation system 105. In embodiments, the delivery specification(s) may be retrieved from the trigger that is received by the advertisement preparation system 105. In embodiments, the advertisement preparation system 105 may identify the targeted client device or client device type from the trigger, and the advertisement preparation system 105 may be configured with delivery specification(s) associated with the identified client device or client device type. In embodiments, the advertisement preparation system 105 may retrieve delivery specification(s) associated with the identified client device or client device type from an external source or server.

At 425, the advertisement media may be transcoded according to the delivery specification(s). The advertisement media may be transcoded according to the delivery specification(s) (e.g., the delivery specification(s) determined at 420), for example, by the advertisement preparation system 105. In embodiments, the advertisement preparation system 105 may utilize an internal transcoder or external transcoding service to transcode the advertisement media.

At 430, the transcoded advertisement media may be output. In embodiments, the transcoded advertisement media may be stored at the advertisement preparation system 105 or other storage that is external to the advertisement preparation system 105. In embodiments, the transcoded advertisement media may be placed into a stream that is then delivered to the targeted client device. In embodiments, the transcoded advertisement media may be output to a delivery network (e.g., CDN 125).

Returning to 410, if the determination is made that the advertisement media is available, the process 400 may proceed to 435. At 435, the advertisement media may be retrieved (e.g., from the CDN 125) and output at 430.

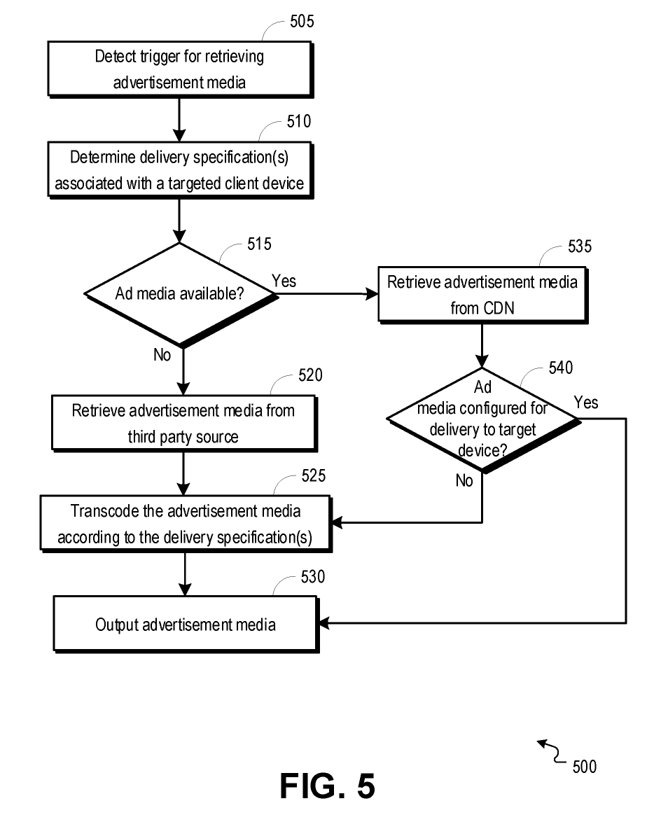

FIG. 5 is a flowchart illustrating an example process 500 operable to facilitate a retrieval and preparation of advertisement media that is retrieved from a third party source or delivery network. The process 500 may start at 505 when a trigger for retrieving advertisement media is detected. The trigger may be detected, for example, by the advertisement preparation system 105 of FIG. 1. In embodiments, the trigger may be a notice of advertisement media locators (e.g., URLs) or advertisement decisions received by the advertisement preparation system 105 from an ADS 110 of FIG. 1 or advertisement decision proxy 205 of FIG. 2. The trigger may include an identification of the advertisement media to be retrieved and an identification of one or more client devices or client types that are to receive the advertisement media. For example, the identification of the advertisement media may include a unique identifier associated with the advertisement media, a locator (e.g., URL) associated with the advertisement media, or other identifier.

At 510, delivery specification(s) associated with a targeted client device may be determined. Delivery specification(s) associated with the targeted client device may be determined, for example, by the advertisement preparation system 105. In embodiments, the delivery specification(s) may be retrieved from the trigger that is received by the advertisement preparation system 105. In embodiments, the advertisement preparation system 105 may identify the targeted client device or client device type from the trigger, and the advertisement preparation system 105 may be configured with delivery specification(s) associated with the identified client device or client device type. In embodiments, the advertisement preparation system 105 may retrieve delivery specification(s) associated with the identified client device or client device type from an external source or server.

At 515, a determination may be made whether the advertisement media identified by the trigger is available. The determination whether the advertisement media is available may be made, for example, by the advertisement preparation system 105. In embodiments, the advertisement preparation system 105 may determine whether the advertisement media is available for delivery to the one or more identified client devices or client types. For example, the advertisement preparation system 105 may determine whether the advertisement media is available within a CDN (e.g., CDN 125 of FIG. 1).

If, at 515, the determination is made that the advertisement media is not available, the process 500 may proceed to 520. At 520, the advertisement media may be retrieved from a third party source. For example, the advertisement media may be retrieved from the third party source (e.g., advertisement media source 120 of FIG. 1) by the advertisement preparation system 105. The third party source may be a source of advertisement media that is located outside of the CDN 125. Using the identification of the advertisement media (e.g., locator, unique identifier, etc.), the advertisement preparation system 105 may retrieve the advertisement media from the third party source.

At 525, the advertisement media may be transcoded according to the delivery specification(s). The advertisement media may be transcoded according to the delivery specification(s) (e.g., the delivery specification(s) determined at 510), for example, by the advertisement preparation system 105. In embodiments, the advertisement preparation system 105 may utilize an internal transcoder or external transcoding service to transcode the advertisement media.

At 530, the transcoded advertisement media may be output. In embodiments, the transcoded advertisement media may be stored at the advertisement preparation system 105 or other storage that is external to the advertisement preparation system 105. In embodiments, the transcoded advertisement media may be placed into a stream that is then delivered to the targeted client device. In embodiments, the transcoded advertisement media may be output to a delivery network (e.g., CDN 125).

Returning to 515, if the determination is made that the advertisement media is available, the process 500 may proceed to 535. At 535, the advertisement media may be retrieved (e.g., from the CDN 125). The advertisement media may be retrieved, for example, by the advertisement preparation system 105.

At 540, a determination may be made whether the retrieved advertisement media is configured for delivery to the targeted client device. The determination whether the retrieved advertisement media is configured for delivery to the targeted client device may be made, for example, by the advertisement preparation system 105. In embodiments, the advertisement preparation system 105 may determine whether the retrieved advertisement media meets the delivery specification(s) associated with the targeted client device (e.g., the delivery specification(s) determined at 510). If the determination is made that the advertisement media is not configured for delivery to the targeted client device, the retrieved advertisement media may be transcoded (e.g., by the advertisement preparation system 105) according to the delivery specification(s) associated with the targeted client device at 525. If the determination is made that the retrieved advertisement media is configured for delivery to the targeted client device, the retrieved advertisement media may be output at 530.

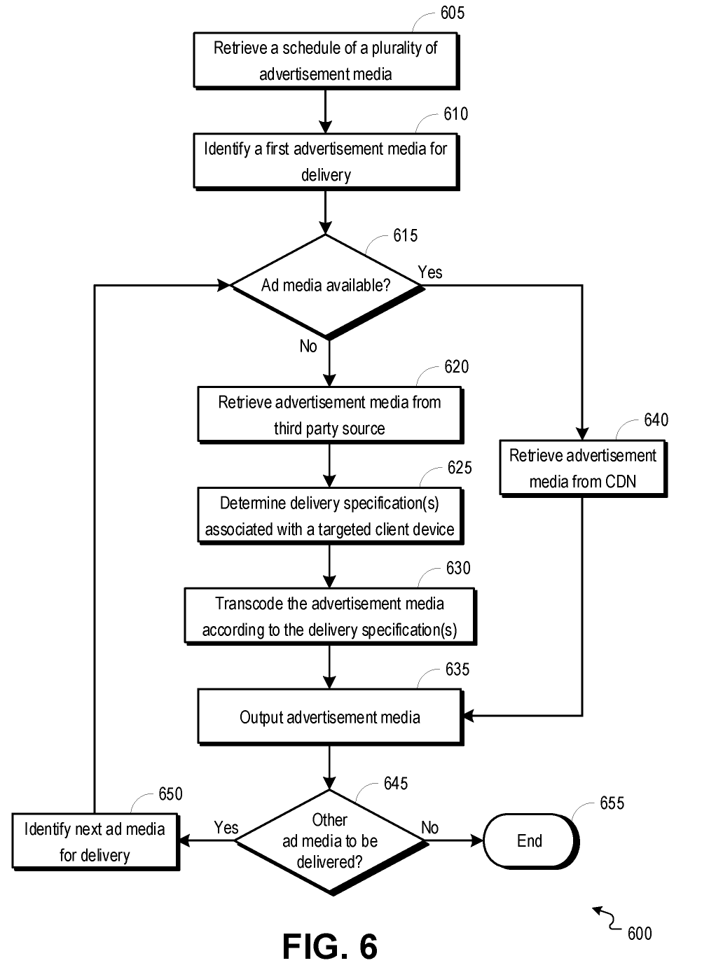

FIG. 6 is a flowchart illustrating an example process 600 operable to facilitate a retrieval and preparation of a plurality of advertisement identified from a schedule. The process 600 may start at 605 when a schedule of a plurality of advertisement media is retrieved. The schedule may be retrieved, for example, by the advertisement preparation system 105 of FIG. 1. The schedule may be retrieved from an ADS 110 of FIG. 1 or advertisement decision proxy 205 of FIG. 2. In embodiments, the schedule may include schedule and delivery information associated with each advertisement media of the plurality of advertisement media. The schedule and delivery information may include advertisement media locators (e.g., URLs), unique identifiers associated with the advertisement media, an identification of one or more client devices or client types that are to receive the advertisement media, respective times at which the advertisement media is to be delivered (e.g., time may be relative to time of delivery associated with the other advertisement media, priority level (e.g., priority level may be relative to priority levels of the other advertisement media), and/or other information.

At 610, a first advertisement media may be identified for delivery. The first advertisement media may be identified, for example, by the advertisement preparation system 105. In embodiments, the advertisement preparation system 105 may identify the first advertisement media based upon the schedule and delivery information associated with each advertisement media of the plurality of advertisement media. For example, the advertisement preparation system 105 may identify the advertisement media having the earliest or nearest (earliest or nearest relative to the other advertisement media) time for delivery as the first advertisement media for delivery. As another example, the advertisement preparation system 105 may identify the advertisement media having the highest (highest relative to the priory levels of the other advertisement media) priority level as the first advertisement media for delivery.

At 615, a determination may be made whether the identified advertisement media is available. The determination whether the identified advertisement media is available may be made, for example, by the advertisement preparation system 105. In embodiments, the advertisement preparation system 105 may determine whether the advertisement media is available for delivery to the one or more identified client devices or client types. For example, the advertisement preparation system 105 may determine whether the advertisement media is available within a CDN (e.g., CDN 125 of FIG. 1).

If, at 615, the determination is made that the identified advertisement media is not available, the process 600 may proceed to 620. At 620, the identified advertisement media may be retrieved from a third party source. For example, the advertisement media may be retrieved from the third party source (e.g., advertisement media source 120 of FIG. 1) by the advertisement preparation system 105. The third party source may be a source of advertisement media that is located outside of the CDN 125. Using the identification of the advertisement media (e.g., locator, unique identifier, etc.), the advertisement preparation system 105 may retrieve the advertisement media from the third party source.

At 625, delivery specification(s) associated with a targeted client device may be determined. Delivery specification(s) associated with the targeted client device may be determined, for example, by the advertisement preparation system 105. In embodiments, the delivery specification(s) may be retrieved from the schedule that is received by the advertisement preparation system 105. In embodiments, the advertisement preparation system 105 may identify the targeted client device or client device type from the schedule, and the advertisement preparation system 105 may be configured with delivery specification(s) associated with the identified client device or client device type. In embodiments, the advertisement preparation system 105 may retrieve delivery specification(s) associated with the identified client device or client device type from an external source or server.

At 630, the identified advertisement media may be transcoded according to the delivery specification(s). The advertisement media may be transcoded according to the delivery specification(s) (e.g., the delivery specification(s) determined at 625), for example, by the advertisement preparation system 105. In embodiments, the advertisement preparation system 105 may utilize an internal transcoder or external transcoding service to transcode the advertisement media.

At 635, the transcoded advertisement media may be output. In embodiments, the transcoded advertisement media may be stored at the advertisement preparation system 105 or other storage that is external to the advertisement preparation system 105. In embodiments, the transcoded advertisement media may be placed into a stream that is then delivered to the targeted client device. In embodiments, the transcoded advertisement media may be output to a delivery network (e.g., CDN 125).

Returning to 615, if the determination is made that the identified advertisement media is available, the process 600 may proceed to 640. At 640, the identified advertisement media may be retrieved (e.g., from the CDN 125) and output at 635.

At 645, a determination may be made whether other advertisement media identified from the schedule is to be delivered. The determination whether other advertisement media identified within the schedule is to be delivered may be made, for example, by the advertisement preparation system 105.

If, at 645, the determination is made that other advertisement media is to be delivered, the process 600 may proceed to 650. At 650, a next advertisement media may be identified for delivery. The next advertisement media may be identified, for example, by the advertisement preparation system 105. In embodiments, the advertisement preparation system 105 may identify the next advertisement media based upon the schedule and delivery information associated with each advertisement media of the plurality of advertisement media. For example, the advertisement preparation system 105 may identify the advertisement media having the next earliest or nearest (earliest or nearest relative to the other advertisement media and the previously output advertisement media) time for delivery as the next advertisement media for delivery. As another example, the advertisement preparation system 105 may identify the advertisement media having the next highest (highest relative to the priory levels of the other advertisement media) priority level as the next advertisement media for delivery.

If, at 645, the determination is made that there is no other advertisement media to be delivered, the process 600 may end at 655.

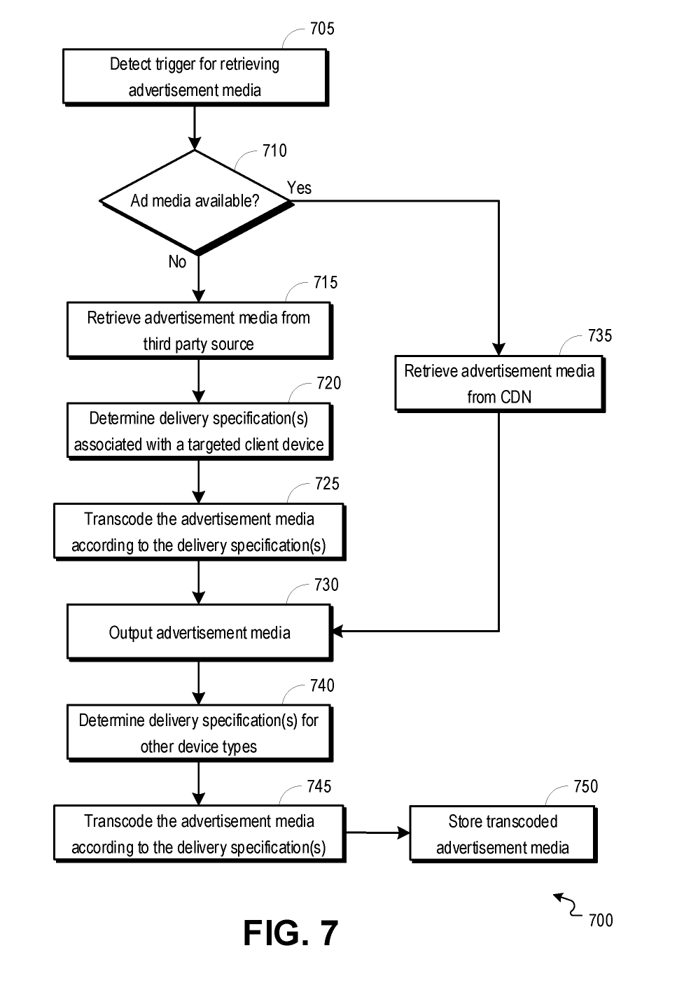

FIG. 7 is a flowchart illustrating an example process 700 operable to facilitate a retrieval and preparation of advertisement media for delivery to a targeted device and one or more other device types. The process 700 may start at 705 when a trigger for retrieving advertisement media is detected. The trigger may be detected, for example, by the advertisement preparation system 105 of FIG. 1. In embodiments, the trigger may be a notice of advertisement media locators (e.g., URLs) or advertisement decisions received by the advertisement preparation system 105 from an ADS 110 of FIG. 1 or advertisement decision proxy 205 of FIG. 2. The trigger may include an identification of the advertisement media to be retrieved and an identification of a targeted client device that is to receive the advertisement media. For example, the identification of the advertisement media may include a unique identifier associated with the advertisement media, a locator (e.g., URL) associated with the advertisement media, and/or other identifier.

At 710, a determination may be made whether the advertisement media identified by the trigger is available. The determination whether the advertisement media is available may be made, for example, by the advertisement preparation system 105. In embodiments, the advertisement preparation system 105 may determine whether the advertisement media is available for delivery to the targeted client device. For example, the advertisement preparation system 105 may determine whether the advertisement media is available within a CDN (e.g., CDN 125 of FIG. 1).

If, at 710, the determination is made that the advertisement media is not available, the process 700 may proceed to 715. At 715, the advertisement media may be retrieved from a third party source. For example, the advertisement media may be retrieved from the third party source (e.g., advertisement media source 120 of FIG. 1) by the advertisement preparation system 105. The third party source may be a source of advertisement media that is located outside of the CDN 125. Using the identification of the advertisement media (e.g., locator, unique identifier, etc.), the advertisement preparation system 105 may retrieve the advertisement media from the third party source.

At 720, delivery specification(s) associated with the targeted client device may be determined. Delivery specification(s) associated with the targeted client device may be determined, for example, by the advertisement preparation system 105. In embodiments, the delivery specification(s) may be retrieved from the trigger that is received by the advertisement preparation system 105. In embodiments, the advertisement preparation system 105 may identify the targeted client device or client device type from the trigger, and the advertisement preparation system 105 may be configured with delivery specification(s) associated with the identified client device or client device type. In embodiments, the advertisement preparation system 105 may retrieve delivery specification(s) associated with the identified client device or client device type from an external source or server.

At 725, the advertisement media may be transcoded according to the delivery specification(s). The advertisement media may be transcoded according to the delivery specification(s) (e.g., the delivery specification(s) determined at 720), for example, by the advertisement preparation system 105. In embodiments, the advertisement preparation system 105 may utilize an internal transcoder or external transcoding service to transcode the advertisement media.

At 730, the transcoded advertisement media may be output. In embodiments, the transcoded advertisement media may be stored at the advertisement preparation system 105 or other storage that is external to the advertisement preparation system 105. In embodiments, the transcoded advertisement media may be placed into a stream that is then delivered to the targeted client device. In embodiments, the transcoded advertisement media may be output to a delivery network (e.g., CDN 125).

Returning to 710, if the determination is made that the advertisement media is available, the process 700 may proceed to 735. At 735, the advertisement media may be retrieved (e.g., from the CDN 125) and output at 730.

At 740, delivery specification(s) associated with one or more other device types may be determined. The one or more other device types may be device types other than the device type associated with the targeted client device. In embodiments, the advertisement preparation system 105 may determine the one or more other device types based upon an identification of the one or more other device types as device types which are likely to or may potentially be targeted for delivery of the retrieved advertisement media. For example, the one or more other device types may be determined based upon a likelihood that the advertisement media will be requested for delivery to the one or more other device types. Delivery specification(s) associated with the one or more other device types may be determined, for example, by the advertisement preparation system 105. In embodiments, the delivery specification(s) may be retrieved from the trigger that is received by the advertisement preparation system 105. In embodiments, the advertisement preparation system 105 may identify the one or more other device types from the trigger, and the advertisement preparation system 105 may be configured with delivery specification(s) associated with the one or more other device types. In embodiments, the advertisement preparation system 105 may retrieve delivery specification(s) associated with the one or more other device types from an external source or server.

At 745, the advertisement media may be transcoded according to the delivery specification(s) associated with the one or more other device types. The advertisement media may be transcoded according to the delivery specification(s) (e.g., the delivery specification(s) determined at 740), for example, by the advertisement preparation system 105. In embodiments, the advertisement preparation system 105 may utilize an internal transcoder or external transcoding service to transcode the advertisement media.

At 750, the advertisement media that is transcoded according to the delivery specification(s) of the one or more other device types may be stored. In embodiments, the transcoded advertisement media may be stored at the advertisement preparation system 105. The transcoded advertisement media may be stored at storage that is external to the advertisement preparation system 105. In embodiments, the transcoded advertisement media may be output to a delivery network (e.g., CDN 125).

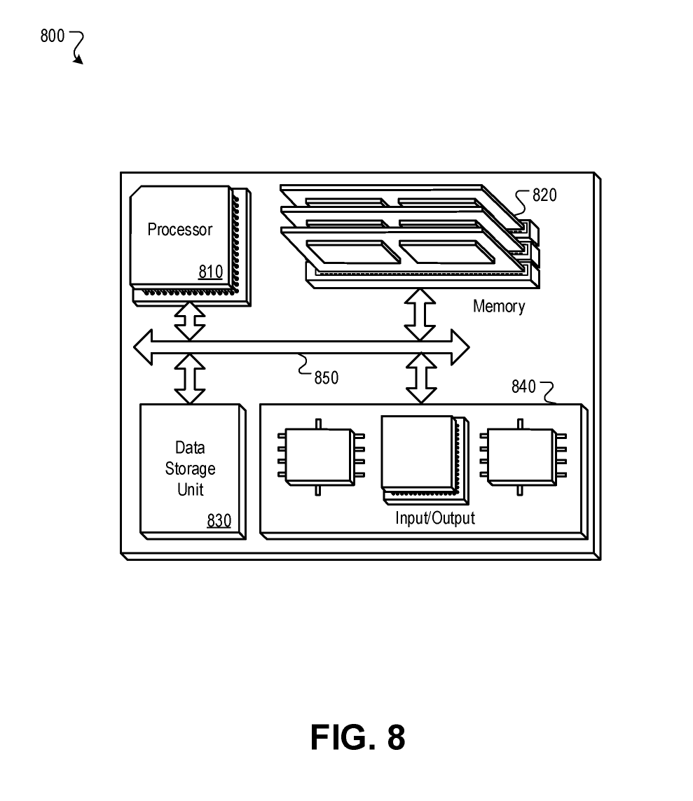

FIG. 8 is a block diagram of a hardware configuration 800 operable to facilitate real-time advertisement preparation. The hardware configuration 800 can include a processor 810, a memory 820, a storage device 830, and an input/output device 840. Each of the components 810, 820, 830, and 840 can, for example, be interconnected using a system bus 850. The processor 810 can be capable of processing instructions for execution within the hardware configuration 800. In one implementation, the processor 810 can be a single-threaded processor. In another implementation, the processor 810 can be a multi-threaded processor. The processor 810 can be capable of processing instructions stored in the memory 820 or on the storage device 830.

The memory 820 can store information within the hardware configuration 800. In one implementation, the memory 820 can be a computer-readable medium. In one implementation, the memory 820 can be a volatile memory unit. In another implementation, the memory 820 can be a non-volatile memory unit.

In some implementations, the storage device 830 can be capable of providing mass storage for the hardware configuration 800. In one implementation, the storage device 830 can be a computer-readable medium. In various different implementations, the storage device 830 can, for example, include a hard disk device, an optical disk device, flash memory or some other large capacity storage device. In other implementations, the storage device 830 can be a device external to the hardware configuration 800.

The input/output device 840 provides input/output operations for the hardware configuration 800. In embodiments, the input/output device 840 can include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for outputting video and/or data services to a CPE device, IP device, mobile device, or other device. In embodiments, the input/output device can include driver devices configured to send communications to, and receive communications from an ADS, an advertisement media source, and/or a CDN.

Those skilled in the art will appreciate that the invention improves upon methods and systems for carrying out real-time preparation of advertisement media. Methods, systems, and computer readable media can be operable to facilitate real-time advertisement preparation. An advertisement preparation system may retrieve requested advertisement media from a third party source. Based upon an identification of a targeted client device that is to receive the advertisement media, the advertisement preparation system may determine delivery specifications associated with the targeted client device. The advertisement preparation system may transcode the retrieved advertisement media according to the delivery specifications associated with the targeted client device, and the transcoded advertisement media may be delivered to the targeted client device.

The methods, systems, and apparatuses described in this disclosure enable the identification and retrieval of one or more preferred or requested media renditions of multimedia content. A subscriber device can maintain a list of media attributes preferred by the subscriber device and/or one or more users with access to the subscriber device, wherein the list includes preferred media attributes in order from the most requested/received attribute to the least requested/received attribute. When the subscriber device receives a request for multimedia content, the subscriber device can identify one or more media attributes preferred by the subscriber, and media renditions of the multimedia content in each of the identified attributes can be downloaded to the subscriber device.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

What is claimed is:

1. A method, comprising:
detecting a trigger for retrieving advertisement media;
retrieving the advertisement media from a third party source;
identifying a targeted client device, wherein the targeted client device is identified from the trigger;
determining one or more delivery specifications associated with the targeted client device;
transcoding the advertisement media according to the one or more delivery specifications associated with the targeted client device; and
outputting the transcoded advertisement media.

2. The method of claim 1, further comprising:
determining that the advertisement media is not available at a content delivery network; and
wherein the advertisement media is retrieved from the third party source in response to the determination that the advertisement media is not available at the content delivery network.

3. The method of claim 1, wherein the trigger comprises a schedule comprising an identification of a plurality of advertisement media and a delivery time associated with each respective one advertisement media of the plurality of advertisement media, wherein the advertisement media that is retrieved from the third party source is identified from the plurality of advertisement media based upon the delivery time associated with the advertisement media.

4. The method of claim 1, wherein the trigger comprises a schedule comprising an identification of a plurality of advertisement media and a priority level associated with each respective one advertisement media of the plurality of advertisement media, wherein the advertisement media that is retrieved from the third party source is identified from the plurality of advertisement media based upon the priority level associated with the advertisement media.

5. The method of claim 1, further comprising:
determining one or more other device types based upon a likelihood that the advertisement media will be requested for delivery to the one or more other device types;
determining one or more delivery specifications associated with each one of the one or more other device types;
transcoding the advertisement media according to the determined one or more delivery specifications; and
storing the transcoded advertisement media.

6. The method of claim 1, wherein the trigger comprises an early advertisement decision that is received from an advertisement decision service.

7. The method of claim 1, wherein the trigger comprises an advertisement media locator that is received from an advertisement decision service.

8. An advertisement preparation system, comprising one or more modules that:
detect a trigger for retrieving advertisement media;
retrieve the advertisement media from a third party source;
identify a targeted client device, wherein the targeted client device is identified from the trigger;
determine one or more delivery specifications associated with the targeted client device;
transcode the advertisement media according to the one or more delivery specifications associated with the targeted client device; and
output the transcoded advertisement media.

9. The advertisement preparation system of claim 8, wherein the one or more modules:
determine that the advertisement media is not available at a content delivery network; and
wherein the advertisement media is retrieved from the third party source in response to the determination that the advertisement media is not available at the content delivery network.

10. The advertisement preparation system of claim 8, wherein the trigger comprises a schedule comprising an identification of a plurality of advertisement media and a delivery time associated with each respective one advertisement media of the plurality of advertisement media, wherein the advertisement media that is retrieved from the third party source is identified from the plurality of advertisement media based upon the delivery time associated with the advertisement media.

11. The advertisement preparation system of claim 8, wherein the trigger comprises a schedule comprising an identification of a plurality of advertisement media and a priority level associated with each respective one advertisement media of the plurality of advertisement media, wherein the advertisement media that is retrieved from the third party source is identified from the plurality of advertisement media based upon the priority level associated with the advertisement media.

12. The advertisement preparation system of claim 8, wherein the one or more modules:
determine one or more other device types based upon a likelihood that the advertisement media will be requested for delivery to the one or more other device types;
determine one or more delivery specifications associated with each one of the one or more other device types;
transcode the advertisement media according to the determined one or more delivery specifications; and
store the transcoded advertisement media.

13. The advertisement preparation system of claim 8, wherein the trigger comprises an early advertisement decision that is received from an advertisement decision service.

14. One or more non-transitory computer readable media operable to execute on a processor, the computer readable being operable to cause the processor to perform the operations comprising:
detecting a trigger for retrieving advertisement media;
retrieving the advertisement media from a third party source;
identifying a targeted client device, wherein the targeted client device is identified from the trigger;
determining one or more delivery specifications associated with the targeted client device;
transcoding the advertisement media according to the one or more delivery specifications associated with the targeted client device; and
outputting the transcoded advertisement media.

15. The one or more non-transitory computer-readable media of claim 14, wherein the computer readable is further operable to cause the processor to perform the operations comprising:
determining that the advertisement media is not available at a content delivery network; and
wherein the advertisement media is retrieved from the third party source in response to the determination that the advertisement media is not available at the content delivery network.

16. The one or more non-transitory computer-readable media of claim 14, wherein the trigger comprises a schedule comprising an identification of a plurality of advertisement media and a delivery time associated with each respective one advertisement media of the plurality of advertisement media, wherein the advertisement media that is retrieved from the third party source is identified from the plurality of advertisement media based upon the delivery time associated with the advertisement media.

17. The one or more non-transitory computer-readable media of claim 14, wherein the trigger comprises a schedule comprising an identification of a plurality of advertisement media and a priority level associated with each respective one advertisement media of the plurality of advertisement media, wherein the advertisement media that is retrieved from the third party source is identified from the plurality of advertisement media based upon the priority level associated with the advertisement media.

18. The one or more non-transitory computer-readable media of claim 14, wherein the computer readable is further operable to cause the processor to perform the operations comprising:
determining one or more other device types based upon a likelihood that the advertisement media will be requested for delivery to the one or more other device types;
determining one or more delivery specifications associated with each one of the one or more other device types;
transcoding the advertisement media according to the determined one or more delivery specifications; and
storing the transcoded advertisement media.

19. The one or more non-transitory computer-readable media of claim 14, wherein the trigger comprises an early advertisement decision that is received from an advertisement decision service.

20. The one or more non-transitory computer-readable media of claim 14, wherein the trigger comprises an advertisement media locator that is received from an advertisement decision service.
